(19) United States
(12) Patent Application Publication
(10) Pub. No.: US 2004/0243028 A1
(43) Pub. Date: Dec. 2, 2004

(54) Apparatus for a recovering exercise for bone-fracture patient

(76) Inventor: Jung-Soo Han, Seoul (KR)

Correspondence Address: DICKSTEIN SHAPIRO MORIN & OSHINSKY LLP, 2101 L STREET NW, WASHINGTON, DC, 20037-1526, US

(21) Appl. No.: 10/486,235

(22) PCT Filed: Jun. 11, 2002
(86) PCT No.: PCT/KR02/01097

(30) Foreign Application Priority Data
Aug. 14, 2001 (KR) 2001/49073

(51) Int. Cl. A61H 1/00

(52) U.S. Cl. 601/34

(57) ABSTRACT

The present invention is constructed with a driving frame (10), an adjustment frame (4) and a support frame (12), the support frame further comprising a front link part (50) hinged at the moving block and a rear link part (52) fixed at the rotational shaft for being bent or extended according to operations of the moving block, the rear link part (52) still comprising a rear main link (54) hinged at the front link part and a rear length adjustment link (78) fixed at the rotational shall to slide along with the rear main link and change the length of the rear link part, whereas the adjustment frame comprises a driving unit (120) for driving the rear length adjustment link, thereby conveniently adjusting the length of the rear link part to the length of a patient's fractured leg for effective recovery exercises.

### FIELD OF THE INVENTION

The present invention relates to an apparatus for a recovering exercise for a bone-fracture patient when the patient tries to exercise his or her fractured bone part.

### BRIEF DESCRIPTION OF THE PRIOR ART

In general, a man moves around with legs. The leg bones like femur, tibia and fibula are often broken or fractured. In order to prevent the fractured part from moving, the fractured bone should be fixed and healed with a plaster cast or a fixing device.

Even when the plaster cast or the fixing device is removed from the broken bone, it is difficult to start an exercise immediately. If any leg fixed for long is abruptly moved, there may be a problem in the fractured bone or joint. Therefore, it is necessary to do exercises gradually to help the healed bone return to its normal functional state.

In this regard, a recovery device has been developed for the purpose of helping a patient to do exercises to fractured and healed legs for a certain period of time. A conventional recovery device is designed for a patient to put his healed leg on a simple support frame for bending or stretching his knee manually or automatically.

However, there is a problem in the conventional recovery device in that each patient has a different leg in length to result in discomfort and low efficiency of doing exercises in the fixed device.

### SUMMARY OF THE INVENTION

The present invention provides an apparatus for a recovering exercise for a bone-fracture patient in which a support frame of with a simple link structure can be conveniently adjusted to the length of patient's leg and that can easily detect a bending or a stretching degree of a knee.

In accordance with an embodiment of the present invention, an apparatus for a recovering exercise for a bone-fracture patient comprises a driving frame having a moving block that moves to a longitudinal direction according to operations of a motor, an adjustment frame coupled at one end of the driving frame with a rotational shaft, a support frame coupled with the moving block and the rotational shaft for putting a patient's fractured leg, wherein the support frame is composed of a front link part hinged at the moving block and a rear link part fixed at the rotational shaft for being bent or extended according to operations of the moving block, while the rear link part is composed of a rear main link hinged at the front link part and a rear length adjustment link fixed at the rotational shaft to slide along with the rear main link to change the length of the rear link part, and wherein the adjustment frame has driving means for driving the rear length adjustment link.

The front link part comprises a front main link, a foot holding panel for putting a patient's foot, a ‘ [symbol] ’ shaped fixing bracket for fixing the foot holding panel and a front length adjustment link slidably coupled with the front main link for changing the length of the front link part, wherein the fixing bracket is fixed by a knob for being turned in relation to the front length adjustment link for assembly.

The front and rear link parts are coupled to maintain in a constant shape of a quadrilateral and to form a fourbar link that are folded or extended. There is a rotational sensor at one or more hinge points of the fourbar link for detecting the folded or extended degree of the link.

The rotational sensor is composed of a body part fixed at one link and a shaft part fixed at the other link for rotating relevantly to the body part.

The driving means comprises an driving screw member rotatively coupled to the rear length adjustment link and screwed at the rear main link for moving in relation to the longitudinal direction of the rear main link, a driving shaft coupled with the rotational shaft for rotating separately from the rotational shaft and coupled with the driving screw member by an driving gear and a motor for rotating the driving shaft.

The driving shaft is fastened at a connecting shaft via the driving gear, and the driving screw member can be fixed at the connecting shaft.

### BRIEF DESCRIPTION OF THE DRAWINGS

Objects and aspects of the invention will become apparent from the following description of preferred embodiments with reference to the accompanying drawings in which:

FIG. 1 is a perspective view illustrating an apparatus for a recovering exercise for a bone-fracture patient in accordance with the present invention;

FIG. 2 is a perspective view illustrating a driving frame shown in FIG. 1;

FIG. 3 is a cross-sectional view cut along arrow line A-A shown in FIG. 2;

FIG. 4 is a perspective view illustrating a support frame shown in FIG. 1 (coupled by changing the direction of a bracket);

FIG. 5 is an exploded, perspective view illustrating part B in FIG. 4;

FIG. 6 is an exploded, perspective view illustrating part C in FIG. 4;

FIG. 7 is an exploded, perspective view illustrating part D in FIG. 4;

FIG. 8 is a cross-sectional view illustrating a rear link part of a rear main link shown in FIG. 4;

FIG. 9 is a perspective view illustrating a front link part shown in FIG. 4;

FIG. 10 is a plan illustrating an adjustment frame (with elimination of a cover) shown in FIG. 1;

FIG. 11 is a front view of FIG. 10;

FIG. 12 is a cross-sectional view illustrating part of driving means of FIG. 11; and

FIG. 13 is a cross-sectional view cut along arrow line E-E in FIG. 11.

### DETAILED DESCRIPTION OF THE INVENTION

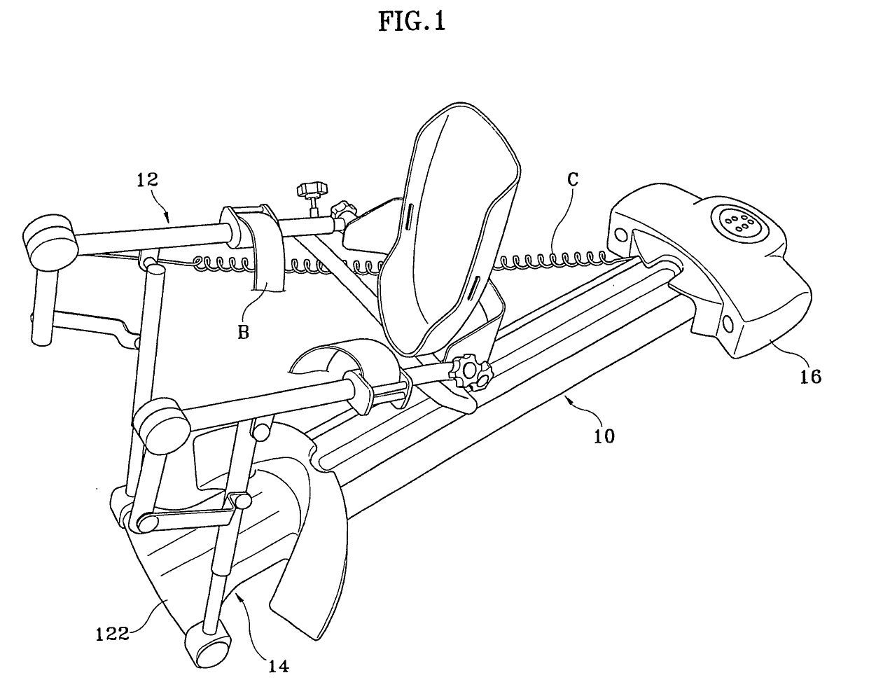

As illustrated in FIG. 1, an apparatus for a recovering exercise for a bone-fracture patient comprises a driving frame 10 having a moving block that moves to the longitudinal direction of the frame according to operations of a motor, an adjustment frame 14 coupled at one end of the driving frame 10 with a rotational shaft, and a support frame 12 coupled with the moving block and the rotational shaft for putting a patient's leg. A control part 16 is coupled at the other end of the driving frame 10 for covering a motor, which will be described below, and for controlling the apparatus for a recovering exercise as a whole.

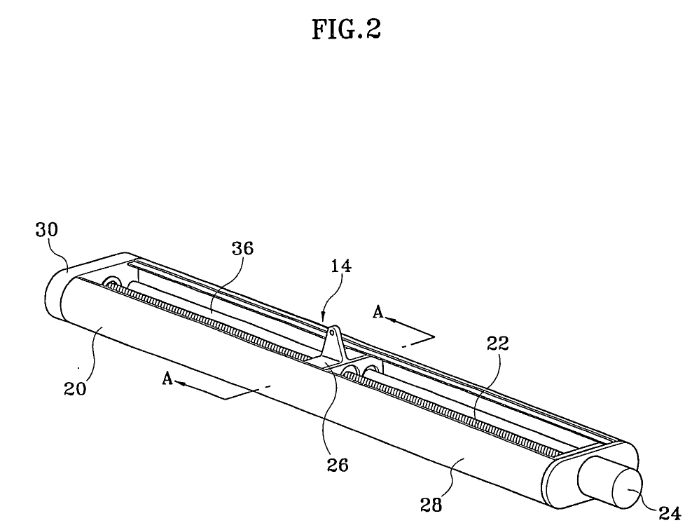

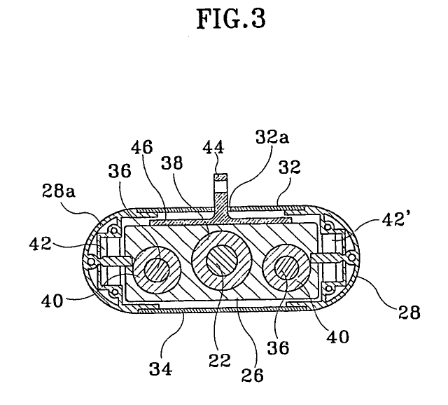

The driving frame 10, as shown in FIGS. 2 and 3, comprises a moving member 22 installed to an internal longitudinal direction of a long case 20, a motor 24 mounted at one side of the case 20 for driving the moving member and a moving block 26 fastened at the moving member for being moved by the moving member 22 that is rotated according to operations of the motor.

The case 20 comprises a lateral member 28 with a pair of semi-circularly shaped long rails 28a. A finishing member 30 is fixed at the open end of the lateral member 28. The upper and lower sides of the lateral member 28 are respectively covered with upper and lower covering members 32, 34. At the upper cover member 32 is formed with a slot groove 32a through which a flange of the moving block 26 passes, which will be described below.

The lower covering member 34 may be integrated with the lateral member 28. FIG. 2 shows a state where the upper covering member 32 is eliminated.

The moving member 22 can be composed of a ball or lead screw. Both ends of the moving member 22 are inserted into the case 20 via bearings. The moving member 22 is connected to the motor shaft of the motor 24. The motor 24 like a stepping motor or servo motor is controlled by the control part 16.

Guide rods 36 are installed in parallel at both sides of the moving member 22 and both ends of the guide rod 36 are fixed to the case 20.

The moving block 26 has a body into which a driving nut 38 is inserted. The driving nut 38 is formed with a ball or a nut having a driving screw externally fit to the moving member 22. Holes are formed at both sides of the moving block 26 for the insertion of bushes 40 through which the guide rods 36 are further passed. In order to support the weight of the moving block 26 and make smooth motions, rollers 42, 42′ are mounted at the external side of the moving block 26 for rolling at the internal side of the lateral member 28. A flange 44 is provided with the upper side of the moving block 26 to be hinged at the front link part of the support frame 12. The flange 44 is fastened with a fastening member (not shown) to the body of the moving block via a base part 46. The flange 44 may be integrally formed at the body of the moving block 26.

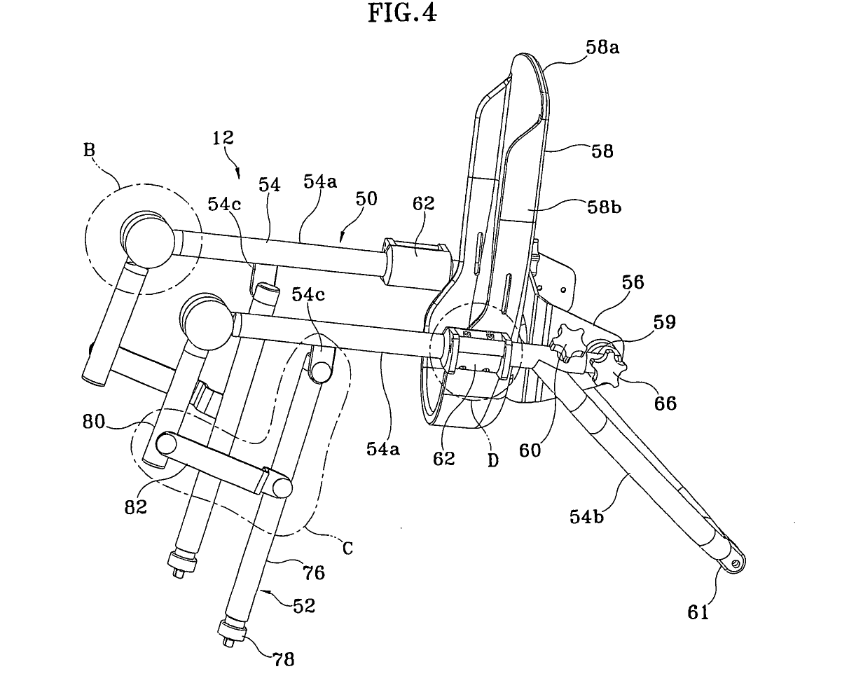

As shown in FIG. 4, the support frame 12 is constructed with a front link part 50 hinged at the moving block 26 and a rear link part 52 fixed at the rotational shaft which will be described below. The front and rear link parts 50, 52 are coupled to maintain in a constant shape of a quadrilateral and to form a fourbar link that are folded or extended according to the movement of the moving block 26.

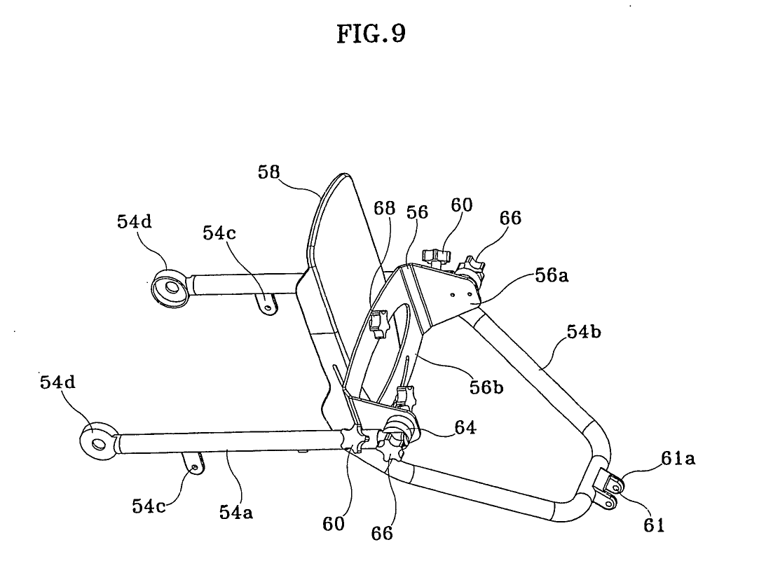

As shown in FIGS. 4 through 9, the front link part 50 is constructed with a ‘ [symbol] ’ shape of a fixing bracket 56 between the two separately diverged front main links 54, 54 and a foot holding panel 58 fixed at the web part of the fixing bracket 56 for holding a foot of a user. Also, a rear length adjustment link 59 is inserted into the front main links 54, 54 to slide and change the length of the front link part 50.

The front main link 54 is constructed with a pair of upper pipe units 54a, 54a and an extended pipe unit 54b tilted and extended down from one end of the upper pipe unit. A hinge bracket 61 is integrated with a flange 61a at the center of the extended pipe unit 54b, that is, a lowest point. The flange 44 of the moving block 26 is inserted into the hinge bracket 61, thereby making it possible to be rotatably fastened around a hinge shaft (not shown).

A knob 60 is fastened at the right side of the upper pipe unit 54a, for fixation of the front length adjustment link 59, whereas a belt fixation unit 62 is installed for fixing a belt (B in FIG. 1) that supports a patient's leg. A flange 54c is formed at the left, center part of the upper pipe part 54a for being coupled with the rear main link of the rear link part 52 which will be described below. A cylindrical flange 54b is formed at the left end of the upper pipes 54a, 54a for being coupled with an auxiliary link, which will be described below.

The fixing bracket 56 looks like a swing panel. In order to get the fixing bracket 56 turned in relation to the front length adjustment link 59 for assembly, the flange 56a is fixed with the knob 66 via an inserting member 64. The base plate of the foot holding panel 58 is fixed by a fixation knob 68 at the web part 56b of the fixation bracket 56.

The foot holding panel 58 is boat-shaped with a predetermined height of a rim part 58b at the edge thereof, except an upper edge of the base plate 58a. The lower part of the rim part 58b is formed higher than its upper part.

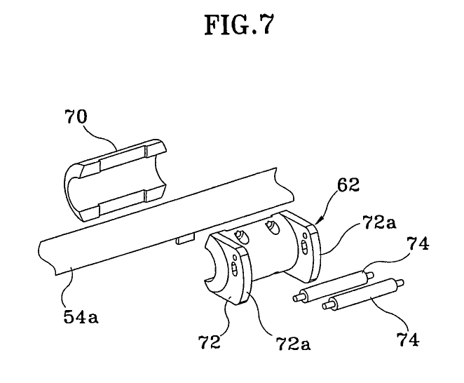

As shown in FIG. 7, the belt fixation unit 62 is made with the two semi-cylindrical caps 70, 72 surrounded and fastened with a bolt. Flanges 72a, 72a are formed from both longitudinal ends of the cap 72 to the vertical, external side of the cap 72. Two rollers 74, 74 are adjacently inserted between the flanges 72a, 72a, and a belt is inserted between the two rollers 74, 74.

As shown in FIGS. 4 through 6, the pare of rear link parts 52 comprises a rear main link 76 hinged at the flange 54c of the front main link 54, a rear length adjustment link 78 fixed at a rotational shaft of the adjustment frame 14, which will be described below, and inserted into the rear main link 76 for sliding and changing the length of the rear link part, an auxiliary link 80 hinged at the cylindrical flange 54d of the front main link 54, and a connecting link 82 hinged in connection of the lower end of the auxiliary link 80 and the central part of the rear main link 76.

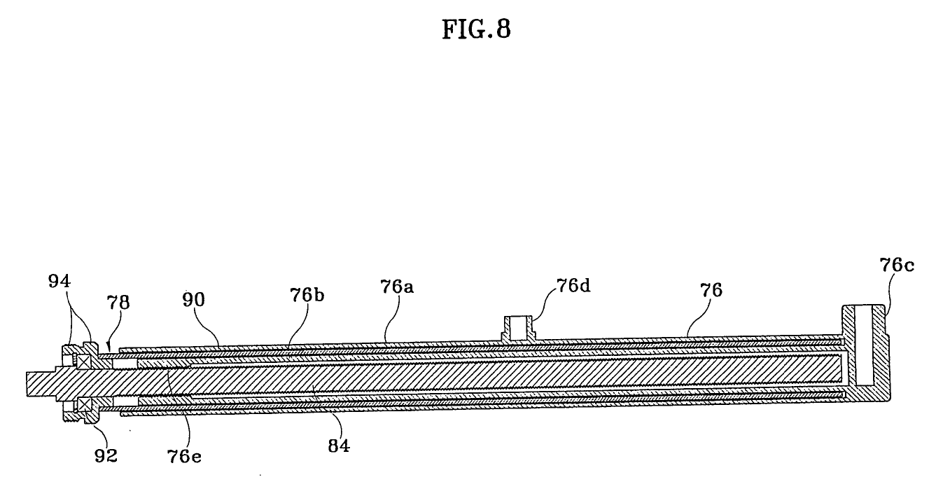

In the rear main link 76 illustrated in FIG. 8, a space is formed between the external and internal pipe parts 76a, 76b to insert a rear length adjustment link 78. A first protruded part 76c is formed at one end of the external side of the external pipe part 76a and a second protruded part 76d is formed in the middle of the external pipe part 76a. A female screw 76e is formed on the internal side of the internal pipe part 76b. A driving screw member 84 of the driving means is screwed to the female screw 76e. The first protruded part 76c is hinged at the flange 54c with a washer 85 and a hinge shaft 86, and the second protruded part 76d is hinged at the one end of the connecting link 82 with a washer 87 and a hinge shaft 88.

The rear length adjustment link 78 comprises a pipe 90 inserted into the space between the external pipe part 76a of the rear main link 76 and the internal pipe part 76b for sliding. A socket 94 is inserted at one end close to a nozzle of the pipe 90, coupled with the driving screw member 84 via a bearing 92 and screwed to the rotational shaft of the adjustment frame 14 which will be described later.

As shown in FIG. 6, the auxiliary link 80 is made of something like a pipe. A cylindrical flange 80a is formed to couple with the cylindrical flange 54d of the front main link 54 at the upper end of the auxiliary link 80, and a protruded part 80b is formed at the external surface of the lower end of the auxiliary link 80. The protruded part 80b is coupled with the other end of the connecting link 82 by the washer 96 and the hinge shaft 98.

At this time, the connecting link 82 is a strip with a bended portion to adjust the deviation of the auxiliary link 80 and the rear main link 76.

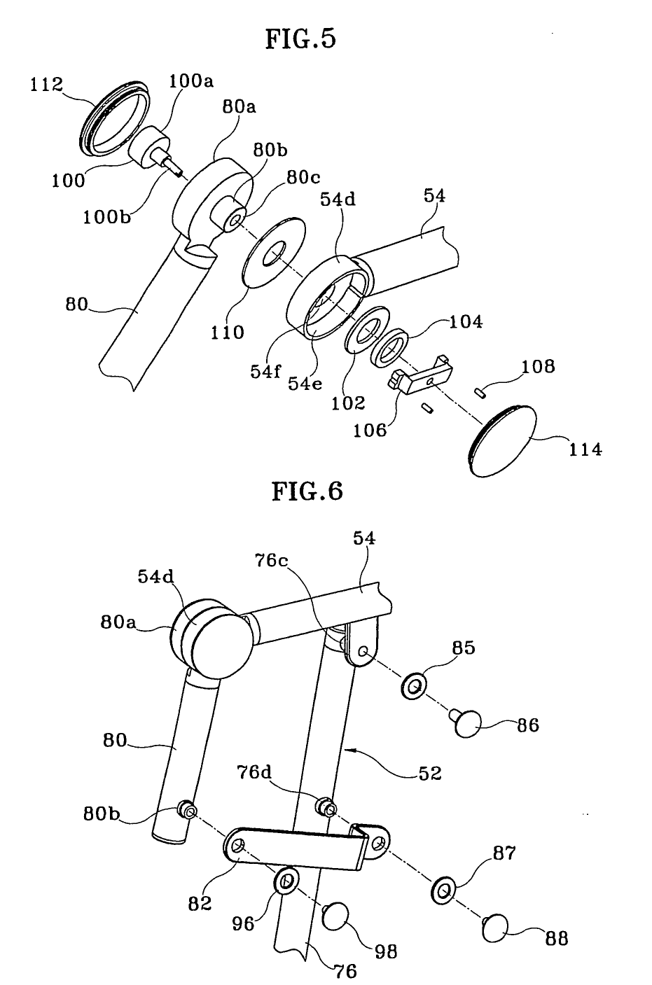

As shown in FIG. 5, an containing room is formed at one side (a back side in the drawing) of the cylindrical flange 80a of the auxiliary link 80, and a protruded shaft 80b is formed with a hole 80c at the center of the other side of the cylindrical flange 80a of the auxiliary link 80. A containing room 54e is formed at one side of the cylindrical flange 54d of the front side (a front side in the drawing) of the front main link 54, and a hole 54f is formed at the other side of the cylindrical flange 54d of the front main link 54 for insertion of the protruded shaft 80b. A rotational sensor 100 is installed at the cylindrical flange 80a, 54d for detecting a relative rotational angle of the front main link 54 and the auxiliary link 80.

The rotational sensor 100 comprises a body part 100a inserted and fixed at the containing room of the cylindrical flange 80a, and an shaft part 100b inserted through the hole 80c and fixed at the containing room 54e of the cylindrical flange 54d. The shaft part 100b rotates in relation to the body part 100a. A washer 102 and a ring 104 are inserted at the protruded shaft 80b through the hole 54f. The shaft part 100b of the rotational sensor is fixed by a locking member 106 and a pin 108. A gap maintaining ring 110 is inserted into the protruded shaft 80b. The containing rooms of the cylindrical flanges 80a, 54d are blocked with caps 112, 114.

The rotational sensor 100 transmits a signal to a circuit board (not shown) of the control part 16 according to a cord C as shown in FIG. 1.

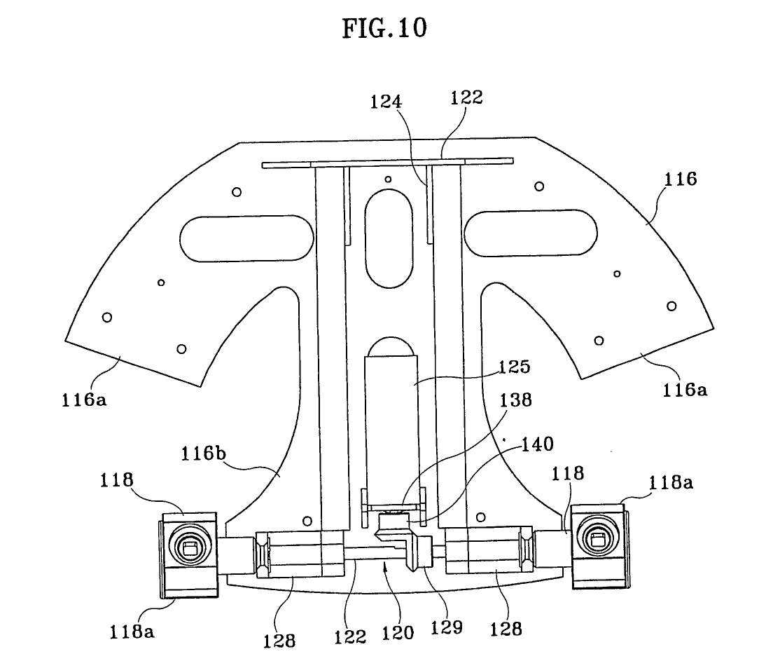

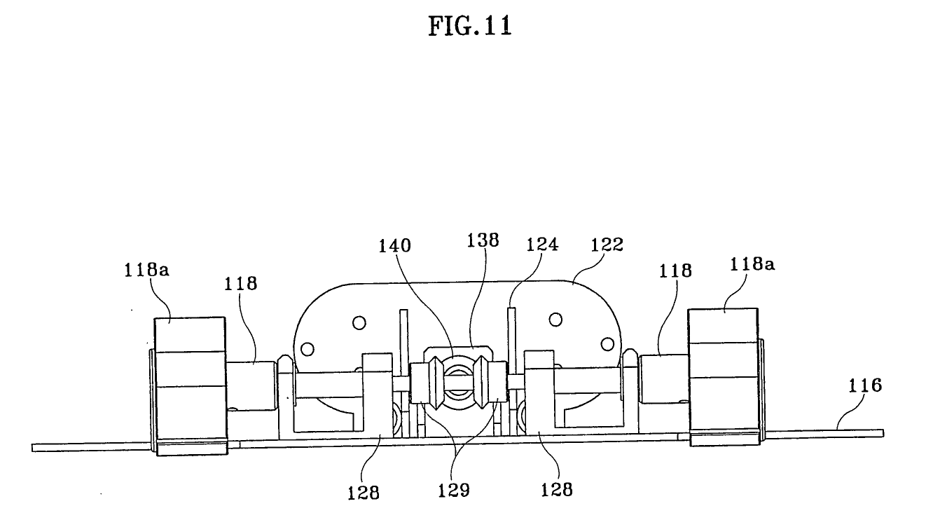

As shown in FIGS. 10, 11, the adjustment frame 14 comprises a rotational shaft 118 receiving a socket 94 of the rear length adjustment link 78 at the upper side of a base plate 116, driving means 120 to drive the rear length adjustment link 78 and a cover (shown in FIG. 1) to make a better appearance. A fixing plate 122 is welded at one end of the base plate 116 for fixing the driving frame 10 and reinforced by a reinforcing rib 124.

The base plate 116 has a wing part 116a extended from the fixing plate 122 to both sides and an extension part 116b extended downwards from the fixing plate 122. The extension part 116b is coupled with driving means 120 and a rotational shaft 118.

The driving means 120 comprises the driving screw member 84 (shown in FIG. 8) coupled for rotations separately from the rear length adjustment link 78 and screwed to the rear main link 76 for moving to the longitudinal direction in relation to the rear main link 76, a driving shaft 122 fixed rotatably in the internal side of the rotational axis 118 independent of the rotational shaft 118 and a motor 125 for rotating the driving shaft 122.

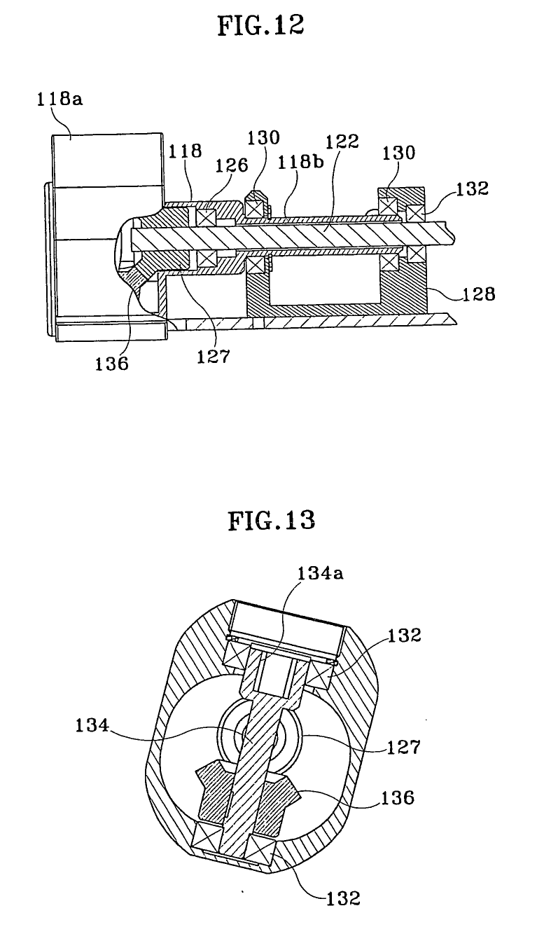

The driving shaft 122 is symmetrically installed on the lower end of the extension part 116b. As shown in FIG. 12, the rotational shaft 118 is fastened at the external left and right edges of the driving shaft 122 via a bearing 126. FIG. 12 is a cross-sectional view illustrating the installation of the driving shaft 122 and the rotational shaft 118 on one side. Bevel gears 127, 129 are respectively fastened at both ends and center of the driving shaft 122.

The rotational shaft 118 is installed on supporting brackets 128, 128 fastened at both lower sides of the extension part 116b via bearings 130, 130. One end of the rotational shaft 118 is coupled to a gear box part 118a with the bevel gears (driving gears) which will be described below, and the other end of the rotational shaft 118 forms a shaft part 118b coupled to the bearings 130, 130.

As shown in FIG. 13, a female screw is formed at the upper end of the gear box part 118a, and a socket 94 of the rear length adjustment link 78 is fastened at the female screw. A connecting shaft 134 is fastened at the internal part of the gear box part 118a via bearings 132, 132. A groove 134a is formed at the upper end of the connecting shaft 134, and the lower end of the driving screw member 84 is inserted and fixed at the groove 134a. A bevel gear 136 is fixed at the connecting shaft 134 for being meshed with the bevel gear 127.

The connecting shaft 134 may be integrated with the driving screw member 84.

The driving shaft 122 is rotated separately from the rotational shaft 118, and one side (close to the center of the driving shaft) of the supporting bracket 128 is to support the driving shaft 122 via a bearing 132.

The motor 125 is installed along the longitudinal direction of the extension part 116b of the base plate at a supporting part 138 vertically set up at the lower part of the extension part 116b. A bevel gear 140 is fixed at the motor shaft of the motor 125 for being meshed with the bevel gear 129.

A user puts his leg at a support panel (not shown, optionally installed) supported by a belt B for recovery exercises and his foot at the holding part of the foot holding panel 58. The amount of exercises, the moving distance of the moving block 26 and the like are set up by manipulations of the control part 16 shown in FIG. 1 to drive the motor 24. Then, the moving block 26 is moved according to rotation of the moving member 22. The operation of the moving block 26 moves the front link part 50 to the longitudinal direction of the driving frame 10.

As the front main link 54 of the front link part moves, the rear link part 52 like a fourbar moves rotatably. The rear main link 76 of the rear link part is rotated around the rotational shaft 118 rotatably coupled at the supporting bracket 128, so that the front and rear link parts 50, 52 are folded or extended to help the user's knee do recovery exercises. At this time, the degree of the user's knee being folded or extended is detected with the rotational sensor 100 coupled at the hinge point of the front main link 54 and the auxiliary link 80, transmitted to the control part 16 for further controls.

The length of a leg below the knee is different from a person to another, so that it is necessary to release the knob 60 and control the degree of manipulating the front length adjustment link 59. As shown in FIGS. 1 and 4, the fixing knob 66 is released and the fixing bracket 56 is inserted to the opposite direction to fasten the foot holding panel 58 at the internal or external side of the web part 56b of the fixing bracket 56 for a convenient use adequately to the length of the leg.

The driving means 120 is driven to adjust the length of the rear link length adjustment link 78 for properly putting in or out of the rear main link 76, so that a user can control the recovery device conveniently to the length of his or her leg for effective recovery exercises. At this time, if the motor 125 is driven, the driving shaft 122 is rotated through the bevel gears 140, 129. The rotational force of the driving shaft 122 is transmitted to the connecting shaft 134 through the bevel gears 127, 136 to rotate the driving screw member 84. Since the driving screw member 84 is screwed to the female screw 76e of the internal pipe part 76b of the rear main link, the rotations of the driving screw member 84 restrict the independent rotations of the rear main link 76, and the rear length adjustment link 78 coupled to the driving screw member 84 via a bearing slides relative to the rear main link 76 to thereby control the length.

It is apparent from the aforementioned description that the invention cannot be restricted in the preferred embodiment but practiced with modifications or changes.

As described above, there are advantages in the recovery device for a fractured patient according to the present invention in that the support frame can be conveniently controlled to the length of a patient's leg due to its simple link structure and it is easy to detect the degree of his knee being folded or extended.

What is claimed is:

1. An apparatus for a recovering exercise for a bone-fracture patient comprising:
a driving frame having a moving block that moves along the longitudinal direction of the frame according to a motor operation;
an adjustment frame attached to one end of the driving frame and having a rotational shaft; and
a support frame coupled to the moving block and the rotational shaft respectively and supporting a patient's leg,
wherein the support frame further comprises a front link part hinged at the moving block and a rear link part fixed at the rotational shaft thereby the support frame being folded or extended according to an operation of the moving block, the rear link part comprises a rear main link hinged at the front link part and a rear length adjustment link fixed at the rotational shaft slidably to the rear main link thereby changing the length of the rear link part, and the adjustment frame comprises driving means for driving the rear length adjustment link.

2. The apparatus as defined in claim 1, wherein the front link part comprises a front main link, a foot holding panel for holding a foot of a patient, a ‘ [symbol] ’ shaped fixing bracket for attachment of the foot holding panel and a front length adjustment link slidably coupled to the front main link for changing the length of the front link part, whereas the fixing bracket is assembled in alternative ways in relation to the front length adjustment link and is fixed by a knob.

3. The apparatus as defined in claim 1, wherein the front and rear link parts are assembled to form a fourbar link maintaining a quadrilateral shape while being folded or extended, and a rotational sensor is provided with one or more hinge points of the fourbar link for detecting the folded or extended state of the link.

4. The apparatus as defined in claim 3, wherein the rotational sensor has the body part fixed at one link part and the shaft part fixed at another link part rotatably to the body part.

5. The apparatus as defined in claim 1, wherein the driving means comprises:
a driving screw member rotatably fixed independent of the rear length adjustment link and screwed to the rear main link for relative motion along the longitudinal direction of the rear main link;
a driving shaft rotatably fixed to the rotational shaft independent of the rotation of the rotational shaft and coupled to the driving screw member by an driving gear; and
a motor for rotating the driving shaft.

6. The apparatus as defined in claim 5, wherein the driving shaft is coupled to a connecting shaft via the driving gear, and the driving screw member is coupled to the connecting shaft.
